(19) United States
(12) Patent Application Publication
(10) Pub. No.: US 2018/0348164 A1
(43) Pub. Date: Dec. 6, 2018

(54) Forward Osmosis Coupled Electrochemical Sensor

(71) Applicant: Northeastern University, Boston, MA (US)

(72) Inventors: Martin KIMANI, Revere, MA (US); Hunter J. SISMAET, Brighton, MA (US); Edgar D. GOLUCH, Somerville, MA (US)

(21) Appl. No.: 15/994,712

(22) Filed: May 31, 2018

Related U.S. Application Data
(60) Provisional application No. 62/512,722, filed on May 31, 2017.

(51) Int. Cl. G01N 27/49; G01N 1/40

(52) U.S. Cl. CPC G01N 27/49; G01N 2001/4016; G01N 1/4005

(57) ABSTRACT

Devices and systems and methods for concentrating and electrochemically detecting an analyte in an aqueous sample are provided. These devices, systems, and methods are useful for detecting an analyte, which as naturally found or produced, occurs at a concentration below that which can be measured using conventional methods.

### CROSS REFERENCE TO RELATED APPLICATIONS

This application claims the benefit under 35 U.S.C. § 119 of U.S. Provisional Patent Appl. No. 62/512,722, filed May 31, 2017, which is incorporated by reference herein in its entirety.

### BACKGROUND

Current methods for reducing water volume to concentrate an aqueous sample require devices such as centrifuges or rotary evaporators which are limited in portability. As such, these methods are unsuitable for many applications, for example, point of care diagnostics. In addition, the closed operation of these systems does not allow for inline monitoring during sample concentration. Point of care low cost diagnostics for bacterial infection still relies heavily on the use of culture plates, which takes 1 to 5 days before a clinician can confirm a bacterial infection and provide the required antibiotic to the patient. Currently available rapid detection techniques include biochemical ELISA kits and LC-MS, but these techniques require costly specialized equipment which is not ideal for large scale implementation (Archibald, M M et al., 2015). Bodily fluid sample concentration is typically conducted using centrifugal ultrafiltration using specified molecular weight cutoff membranes.

There is a need for low cost and portable devices for concentrating and detecting an analyte of interest in an aqueous sample.

### SUMMARY

A technology for concentrating and electrochemically detecting an analyte in an aqueous sample is described. The technology includes a device, a system, and a method for concentrating and electrochemically detecting an analyte.

In one aspect, the present technology provides a device for concentrating and electrochemically detecting an analyte in an aqueous sample. The device includes a first chamber for concentrating the sample. The chamber has an inlet for loading the sample into the chamber, an outlet for allowing the sample to exit the chamber, a working electrode, and a counter electrode. The working electrode and counter electrode are disposed to contact the sample in the chamber. The device further includes a second chamber for a draw solution and a semipermeable membrane separating the first and second chambers.

In another aspect, the present technology provides a device for concentrating and electrochemically detecting an analyte in a sample. The device includes a first chamber for concentrating the sample. The chamber includes an inlet for loading the sample into the chamber and an outlet for allowing the sample to exit the chamber. Further included in the device is a second chamber for a draw solution, a semipermeable membrane separating the first and second chambers, and a third chamber for electrochemically detecting the analyte in the concentrated sample from the first chamber. The third chamber includes an inlet, an outlet, a working electrode, and a counter electrode. The working electrode and counter electrode are disposed to contact the concentrated sample in the third chamber. Also included in the device is a channel fluidically connecting the outlet of the first chamber with the inlet of the third chamber.

The above-described devices can further include one or more of any of the following features. The devices can further include a reference electrode in either the first chamber (two chamber device) or the third chamber (three chamber device), such that the reference electrode is disposed to contact the sample. The volume of the second chamber of the devices is between 10 to 100 times greater than the volume of the first chamber. The second chamber can be filled with a draw solution having an osmolarity higher than that expected for the sample. The semipermeable membrane can have a cut-off in the range of about 100 Daltons to about 500 Daltons. The devices can comprise two or more pairs of first and second chambers for progressive concentration of the sample, each pair being separated by a semi-permeable membrane. The pairs are fluidically connected in series via one or more channels from the outlet of one first chamber to the inlet of another first chamber, or to the inlet of a separate third chamber for electrochemically detecting the analyte in the concentrated sample. The devices can comprise three or more pairs of first and second chambers and are capable of at least 10-fold concentration of the analyte in the sample, e.g. capable of at least 100-fold concentration of the analyte in the sample. A surface of the working electrode can be functionalized to specifically bind the analyte. Functionalization can be done coupling an antibody or antigen-binding fragment thereof, or an aptamer, to the surface of the working electrode exposed to the sample. The analyte binding moiety (antibody or aptamer) can be covalently coupled to the electrode surface, optionally via a linker, and optionally with an electrochemically active moiety that is able to undergo electrochemical reaction at the electrode surface only when the analyte is bound to the analyte binding moiety. The devices can be configured as point of care sensors for detecting or quantifying an analyte from a patient sample. The devices can be configured as sensors for use with a bioreactor, such that they detect or quantify an analyte produced by the bioreactor. The devices can be configured for inline monitoring of a continuously produced fluid sample, such as a body fluid from a patient or a sample from a bioreactor. The devices can be configured to be disposable.

In yet another aspect, the present technology provides a system that includes any of the above-described devices and a potentiostat connected to the working electrode, counter electrode, and optionally to a reference electrode via electrode leads. Optionally, the system can also include a device for measuring electrical conductivity of the sample solution, such as during concentration of the sample. The system may further include a processor and memory for evaluating and/or quantifying the analyte, and optionally comprise a wireless transmitter. The system having a wireless transmitter may further include a separate receiver device for receiving signals remotely from the device for concentrating and electrochemically detecting the analyte. Further, the system may be configured or programmed to detect or quantify a concentration factor of the sample during a process of concentrating the sample. The system may also be configured or programmed to change or replenish a draw solution in the second chamber. The system may optionally include one or more pumps, valves, vacuum lines, or pressurized gas or fluid lines to facilitate fluid transfer between devices of the system or parts of the devices.

In a further aspect, the technology provides a method for concentrating an analyte in an aqueous sample and electrochemically detecting and/or quantifying the analyte. The method includes: (a) providing any of the above-described devices or systems in which the second chamber includes a draw solution; (b) introducing the sample into the first chamber through the inlet; (c) concentrating the sample by forward osmosis, whereby water is transferred from the first to the second chamber; (d) establishing an electrical potential difference between the working electrode and the counter electrode; (e) measuring a current from an electrochemical reaction involving the analyte at the working electrode; and (f) determining a presence, amount, or concentration of the analyte in the sample from the current measured in (e) and a concentration factor achieved in (c).

The method can further include one or more of the following features. It can further include determining the concentration factor achieved in (c) from conductivity measurements of the sample before, during, and/or after performing (c). Step (f) can comprise comparing the current measured in (e) with a known correlation between the current and concentration of the analyte. The draw solution can contain, e.g., sucrose or potassium chloride, or another solute that is preferably inert with respect to the intended sample, and highly soluble in aqueous solutions so as to achieve a high concentration and osmotic pressure in the draw solution. The sample can be, for example, a body fluid of a patient, a cell culture medium, or a solution from a bioreactor. Detection limit of the analyte can be increased at least 10-fold by the method compared to an electrochemical measurement made using the sample without concentration.

The technology is further summarized in the following list of embodiments.

1. A device for concentrating and electrochemically detecting an analyte in an aqueous sample, the device comprising:

a first chamber for concentrating the sample, the chamber comprising an inlet for loading the sample into the chamber, an outlet for allowing the sample to exit the chamber; a working electrode, and a counter electrode, wherein the working electrode and counter electrode are disposed to contact the sample in the chamber;

a second chamber for a draw solution; and

a semipermeable membrane separating the first and second chambers.

2. A device for concentrating and electrochemically detecting an analyte in a sample, the device comprising:

a first chamber for concentrating the sample, the chamber comprising an inlet for loading the sample into the chamber and an outlet for allowing the sample to exit the chamber;

a second chamber for a draw solution;

a semipermeable membrane separating the first and second chambers;

a third chamber for electrochemically detecting the analyte in the concentrated sample from the first chamber, the third chamber comprising an inlet, an outlet, a working electrode, and a counter electrode, wherein the working electrode and counter electrode are disposed to contact the concentrated sample in the third chamber; and

a channel fluidically connecting the outlet of the first chamber with the inlet of the third chamber.

3. The device of embodiment 1, further comprising a reference electrode in the first chamber, wherein the reference electrode is disposed to contact the sample in the first chamber.
4. The device of embodiment 2, further comprising a reference electrode in the third chamber, wherein the reference electrode is disposed to contact the sample in the third chamber.
5. The device of embodiments 1 or 2, wherein the volume of the second chamber is greater than the volume of the first chamber.
6. The device of embodiments 1 or 2, wherein the second chamber is filled with a draw solution having an osmolarity higher than that expected for the sample.
7. The device of embodiments 1 or 2, wherein the semipermeable membrane has a cut-off in the range of about 100 Daltons to about 500 Daltons.
8. The device of embodiments 1 or 2, wherein the device comprises two or more pairs of first and second chambers for progressive concentration of the sample, each pair separated by a semi-permeable membrane, wherein the pairs are fluidically connected in series via one or more channels from the outlet of one first chamber to the inlet of another first chamber, or to the inlet of a separate third chamber for electrochemically detecting the analyte in the concentrated sample.
9. The device of embodiment 8 comprising three or more pairs of first and second chambers and capable of at least 10-fold concentration of the analyte in the sample.
10. The device of embodiment 9 that is capable of at least 100-fold concentration of the analyte in the sample.
11. The device of embodiments 1 or 2, wherein a surface of the working electrode is functionalized to specifically bind the analyte.
12. The device of embodiment 11, wherein the working electrode is functionalized by an antibody or antigen-binding fragment thereof, or by an aptamer.
13. The device of any of the preceding embodiments that is configured as a point of care sensor for detecting or quantifying an analyte from a patient sample.
14. The device of any of embodiments 1-12 that is configured as a sensor for use with a bioreactor, wherein the device detects or quantifies an analyte produced by the bioreactor.
15. The device of any of the preceding embodiments configured for inline monitoring of a continuously produced fluid sample.
16. The device of any of the preceding embodiments that is configured as disposable.
17. A system comprising the device of any of the preceding embodiments and a potentiostat connected to the working electrode, counter electrode, and optionally to a reference electrode via electrode leads.
18. The system of embodiment 17, further comprising a processor and memory for evaluating and/or quantifying the analyte, and optionally comprising a wireless transmitter.
19. The system of embodiment 18 having a wireless transmitter, further comprising a separate receiver device for receiving signals remotely from the device for concentrating and electrochemically detecting the analyte.
20. The system of any of embodiments 17-19 configured or programmed to detect or quantify a concentration factor of the sample during a process of concentrating the sample.
21. The system of any of embodiments 17-20 configured or programmed to change or replenish a draw solution in the second chamber.
22. A method for concentrating an analyte in an aqueous sample and electrochemically detecting and/or quantifying the analyte, the method comprising:

(a) providing the device of any of claims 1-16 or the system of any of claims 17-21, wherein the second chamber comprises a draw solution;

(b) introducing the sample into the first chamber through the inlet;

(c) concentrating the sample by forward osmosis, whereby water is transferred from the first to the second chamber;

(d) establishing an electrical potential difference between the working electrode and the counter electrode;

(e) measuring a current from an electrochemical reaction involving the analyte at the working electrode; and

(f) determining a presence, amount, or concentration of the analyte in the sample from the current measured in (e) and a concentration factor achieved in (c).

23. The method of embodiment 22, further comprising determining the concentration factor achieved in (c) from conductivity measurements of the sample before, during, and/or after performing (c).
24. The method of embodiment 22 or 23, wherein (f) comprises comparing the current measured in (e) with a known correlation between the current and concentration of the analyte.
25. The method of any of embodiments 22-24, wherein the draw solution comprises sucrose or potassium chloride.
26. The method of any of embodiments 22-25, wherein the sample is a body fluid of a patient, a cell culture medium, or a solution from a bioreactor.
27. The method of any of embodiments 22-26, wherein the detection limit of the analyte is increased at least 10-fold by the method compared to an electrochemical measurement made using the sample without concentration.

### BRIEF DESCRIPTION OF THE DRAWINGS

FIGS. 1A and 1B are schematic diagrams of different embodiments of a device for concentrating and electrochemically detecting an analyte in an aqueous sample.

FIG. 2A is a schematic diagram of a prototypical microfluidic device for concentration of a sample using forward osmosis. The device is coupled to an electrochemical sensor. The sensor is made of carbon & copper and is disposable. Forward osmosis is carried out using a cellulose ester membrane that is permeable to water but limits the movement of salt and sugar through the membrane.

FIG. 2B shows the prototypical microfluidic device described schematically in FIG. 2A.

FIG. 3 is a diagram showing the fabrication and assembly of the microfluidics device illustrated in FIGS. 2A and 2B.

FIGS. 4A-4C show data for calibration of salt and sugar concentration measured by impedance-based conductivity measurement. FIG. 4A shows impedance values obtained for KCl solutions at different concentrations as a function of frequency. FIG. 4B shows variation in conductivity of NaCl and KCl solutions as a function of salt concentration. FIG. 4C shows current measured as a function of applied potential (Ag/AgCl used as a reference electrode) at the indicated KCl concentrations.

FIG. 5 is a graph showing the impact of osmotic pressure on water permeability and reverse permeability of sucrose and KCl from draw solutions.

FIG. 6 is a graph showing the dependence of water flux on temperature. Temperatures above 40° C. reduced water flux rates in both sugar- and salt-based osmotic systems.

FIG. 7 is a graph showing the dependence of reverse flux of sucrose on temperature. Significantly higher sucrose reverse flux rate was observed at 60° C. than that observed at 22 and 40° C.

FIG. 8 is a graph showing the impact of pH on water permeability when sugar was used as the draw solute. Permeability was slower at relatively basic pH.

FIG. 9 is a graph showing the impact of pH on sucrose reverse flux. Slower reverse flux was observed at more basic pH.

FIG. 10 is a graph showing the impact of pH on reverse flux of KCl. Slower reverse flux was observed at relatively basic pH.

FIG. 11A is a graph showing rise in PBS salt concentration and fall in PBS volume (PBS solution used as sample) as a function of time using sucrose as the draw solution. FIG. 11B is a graph showing change in the extent of PBS salt concentration with time.

FIG. 12 is a graph showing that the relationship between the time and the extent of concentration (concentration factor) is linear for concentrations determined by both volumetric and impedance measurements.

FIGS. 13A and 13B are graphs showing the use of phosphate buffered saline (PBS) as a surrogate for a body fluid. FIG. 13A shows variation in conductivity as a function of increasing concentration of PBS. FIG. 13B shows the linear nature of increase in concentration of PBS with time.

### DETAILED DESCRIPTION

Provided herein are devices, systems, and methods for concentrating and electrochemically detecting an analyte in an aqueous sample. The technology allows for detection and quantification of analytes that are under the detection limit of conventional electrochemical detection as they occur in unmodified samples. The technology also allows for monitoring the concentration of some analytes while the concentration of the sample containing the analyte is underway.

According to the present technology, an electrochemical sensor is used for monitoring the concentration of an analyte contained in a sample. Electrochemically active analytes, after concentration, can be detected and/or quantified directly by conventional electrochemistry, whereas electrochemically inactive analytes can be detected and/or quantified by functionalization of the working electrode of the device. The sensor device includes a working electrode, a counter electrode, and optionally, a reference electrode. The device uses low cost dialysis membranes, and concentration is achieved by forward osmosis. The device can be attached to another device, e.g., allowing inline concentration of analyte, such as a biomolecule being produced in a bioreactor. Systems including the device and methods for concentrating an analyte in a sample using the device are also provided.

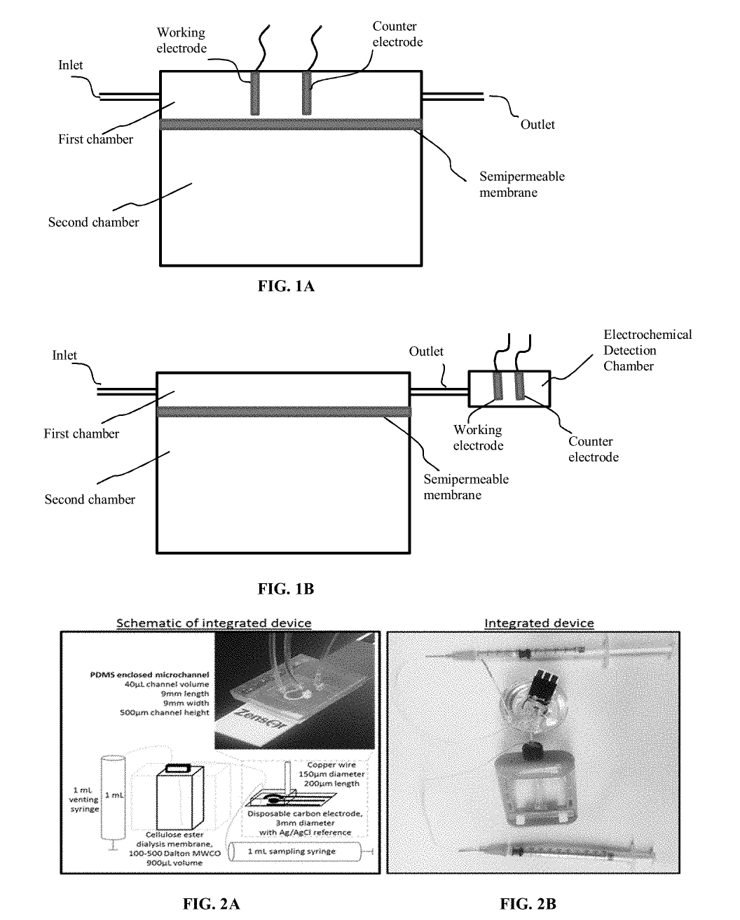

One embodiment of the device 10 is schematically shown in FIG. 1A. A chamber for concentrating the sample (first chamber 20) is depicted. This chamber comprises an inlet 21 for loading the sample into the chamber as well as an outlet 22 for allowing the sample to exit the chamber. Also shown is a working electrode 23 and a counter electrode 24. Both electrodes are disposed to contact the sample in the chamber. A second chamber 30 is provided for a draw solution, and a semipermeable membrane 40 is shown separating the first and second chambers. In another embodiment of the device, shown in FIG. 1B, the working and the counter electrodes are part of an electrochemical detection chamber 50. This chamber is fluidically connected to the first chamber and can be loaded with concentrated sample from the first chamber.

The second chamber is preferably larger than the first chamber, so as to minimize dilution of the draw solution with water removed from the sample. In general, the second chamber is 10- to 50-fold larger than the first chamber; however, it can be larger by 100-fold or more. In addition to the first and the second chamber being disposed side-by-side, the first chamber may be sumersed within the second chamber to provide a larger surface area for forward osmosis to occur, and thereby speed up the concentration process. Further, the first and second chambers can have any desired shape, such as cuboid, rectangular prism, or cylindrical. The first chamber may be a microfluidic channel with the capacity to hold a small sample volume, such as a volume of 10 mL or less, 5 mL or less, 2 mL or less, 1 mL or less, 500 μL or less, 200 μL or less, or 100 μL or less. Smaller sample volumes, such as less than 1 mL, permit quicker concentration of the sample, and are especially preferred when the device is intended for inline (e.g., continuous flow) operation. The design of the first and second chambers is preferably optimized to ensure rapid concentration of the sample. This can be achieved by maximizing the surface area of the semi-permeable membrane at the junction between the first and second chambers, such as by making the first chamber as thin as possible. The first and second chamber can be attached to one another by a clamp or screw mechanism to hold them together and hold the semi-permeable membrane in place, and to allow for exchange of the semi-permeable membrane between runs. Alternatively, the first and second chamber and semi-permeable membrane can be permanently attached, such as by glue or welding.

Many different solutes can be used to prepare the draw solution for use in the present technology. A suitable draw solute, when paired with a selected semi-permeable membrane, should provide an optimum osmotic pressure gradient (high osmotic pressure within the draw solution and low reverse flux). Ammonium carbonate, owing to its high osmotic pressure, is a widely used draw solute (to draw water from sea water, river water, and contaminated water) and may be used in the devices and methods described herein. Other draw solutes that may be use include sugars, inorganic or organic salts, and polyelectrolytes (e.g., poly(sodium acrylate)) as well as many others described in WO/2014/175833, which is incorporated herein by reference. Draw solutions for use with the present device may be used at high concentrations, for example, at concentrations 1000 times the concentration of the analyte in the sample. Draw solutions preferably use a solute present at or near its maximum solubility.

Many different forward osmosis membrane designs and materials can be used in the devices described herein. These include, but are not limited to: cellulose acetate and cellulose triacetate (CTA) membranes, thin film composite polyamide-based forward osmosis membranes formed by phase-inversion (support membrane) and interfacial polymerization (active layer), thin film composite polyamide-based forward osmosis membranes based on electrospun nanofiber webs (support membrane) and interfacial polymerization (active layer), and thin film composite polyelectrolyte-based forward osmosis membranes formed by phase-inversion (support membrane) and layer-by-layer deposition (active layer). Commercial sources from which forward osmosis membranes for use in the present technology may be obtained include HTI, ZNano, Porifera, and Sterlitech. Hollow fiber membranes, which have a semi-permeable membrane in the form of a hollow fiber, may also be used in the present technology. The membrane can have a cut-off in the range of about 100-200 Daltons (Da), about 200-300 Da, about 300-400 Da, about 400-500 Da, about 500-600 Da, about 600-700 Da, about 100-300 Da, about 200-400 Da, about 300-500 Da, about 400-600 Da, about 500-700 Da, about 100 to 500 Da, about 200-600 Da, about 1000 Da or about 300-700 Da. A suitable membrane is selected based in part on the choice of draw solution used and the size of the analyte being concentrated. The membrane must allow the permeation of water molecules but limits or minimizes the permeation of solute in the draw solution as well as solute in the sample. The membrane should be essentially impermeable to the analyte.

The analyte sought to be detected is preferably a redox-active molecule. Any redox active molecule can be used if its redox potential is known and substantially unique within the sample analyzed. For example, the redox molecule can be a metabolite, toxin, antigen, peptide, proteins, glycoprotein, nucleic acid, polysaccharide, lipid, or small molecule drug. An example of a redox-active molecule which is also important in healthcare delivery is pyocyanin, a virulence factor produced by Pseudomonas aeruginosa. Pseudomonas aeruginosa is a gram-negative bacterium and a common cause of nosocomial infections in hospitalized patients and is responsible for 10 percent of all hospital acquired infection.

In cases where the analyte is not redox-active, the working electrode can be functionalized. The working electrode may be functionalized, for example, by attaching an antibody specific to the analyte. Recognition of the analyte by the antibody may be detected by the accompanying change in the structure of the antibody. A reagent that can specifically recognize the altered antibody is linked to a generic redox-active molecule may be used for this purpose. Binding of antibody to the analyte brings the reagent to the proximity of the electrode surface, thereby allowing electron transfer between the electrode and the reagent.

The analyte is present in a sample that is preferably an aqueous solution, although it may contain other polar solvents, such as alcohols, that do not lead to phase separation. The sample can be, for example, any bodily fluid from a human or other animal, or a tissue sample or cell sample from any living creature, including plants and microbes; the tissue or cell sample can be disrupted or homogenized prior to concentration using the present method, device, or system. The sample also can be a cell culture medium (eukaryotic or bactierial), either with or without cells suspended in it. The sample also can be a chemical or biochemical reaction mixture, such as from a synthesis or production of a chemical compound, or a recombinant protein or other bacterial product. Detection of an analyte in the sample can serve the purpose of detecting the presence of the analyte or an agent that produces the analyte, such as a pathogen or cell. It can also serve the purpose of assaying the amount or concentration of the analyte in a reaction, a bioreactor, or a patient's body, or the presence or absence of a medical condition in the patient.

The operability of the device was evaluated in a number of experiments. These studies used two draw solutions, namely, KCl solution and sucrose solution. A 100-500 Da cut-off cellulose ester membrane was used as the forward osmosis membrane. Effects of temperature and pH were examined. Using the device, a phosphate buffered saline (PBS) solution was concentrated down to twenty-fold in under 2 hours. These studies are described in detail in the Examples that follow

### EXAMPLES

### Example 1. Microfluidic Device Fabrication

Insulated copper electrodes from an ethernet cable were cut using wire cutters to a length of 10 cm. The exposed wire at the end of the insulation was reviewed under a microscope. The wire had a diameter of 150 μm and exposed length of 200 μm. About 2 cm of the wire at the other end was also exposed for making connection with an electrochemical workstation.

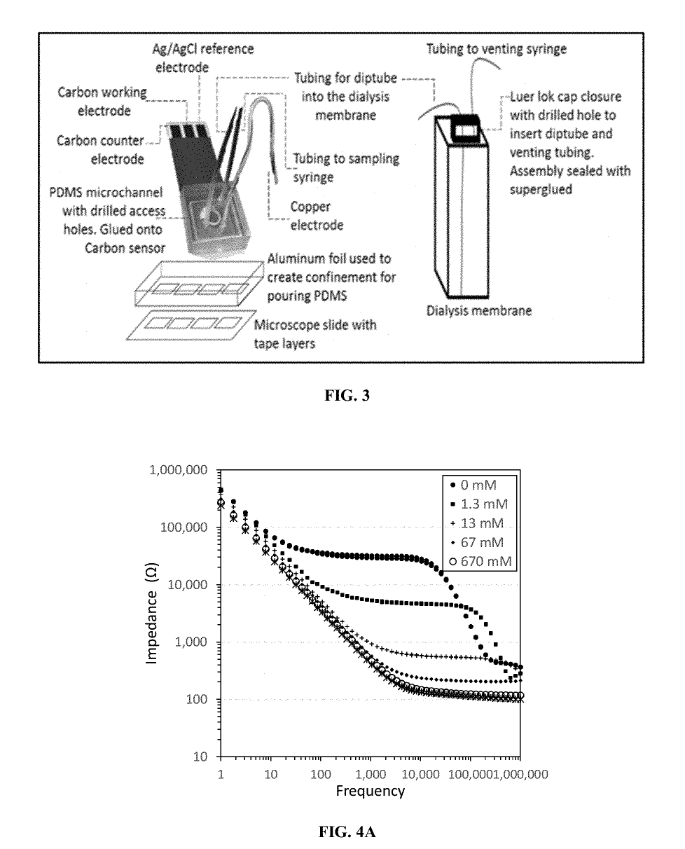

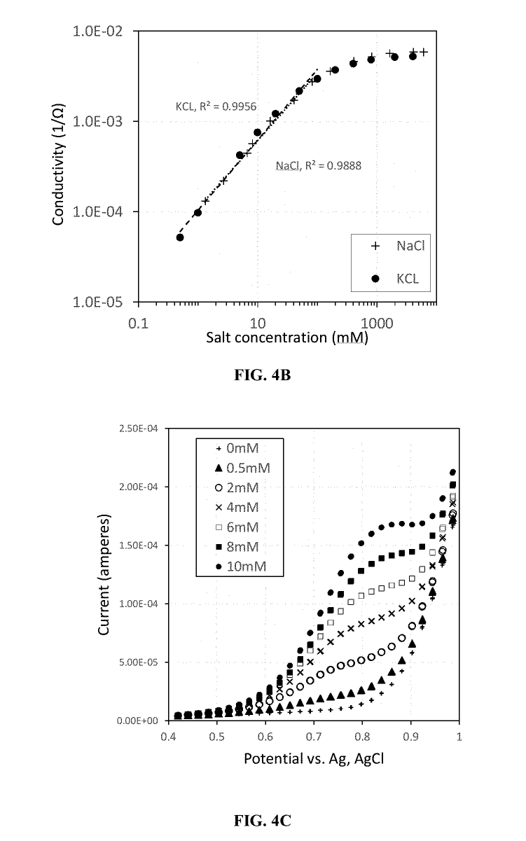

A PDMS (polydimethylsiloxane) enclosed microchannel for inline sample analysis was fabricated by making a mold using 7.5 mm glass slides and adhesive tape. A layer of tape was cut into squares having sides of 9 mm and placed onto the glass slide. Aluminum foil was used to surround the edges of the slide to hold PDMS solution when poured onto the slide. A solution (30 ml) of 10:1 PDMS base to curing agent was poured onto the mold while ensuring that the final PDMS level was above the tape features. The assembly was degassed under vacuum for 15 minutes and placed in an oven for curing at 80° C. for 1 hour. The cured PDMS was removed from the oven and the edges trimmed using a razor blade so that the microchannel formed covered the section of the Zensor disposable carbon electrode footprint (see FIG. 3). Next, using a 15-gauge stainless steel needle, three access holes were drilled on the cured PDMS for inline/outlet tubing connections and copper electrode placement in the microchannel as shown in FIGS. 2A and 2B. A hot glue gun was used to seal the copper electrode and tubing onto the PDMS assembly. Finally, the microchannel was glued onto the disposable carbon electrode. A 23-gauge needle, fitted with a luer lock, was inserted at one end of a tubing, the other end of which was inside the PDMS assembly. A one milliliter syringe was connected to needle. The syringe served as the sampling device.

A second tubing from the PDMS assembly was inserted into a microdialysis membrane tube to serve as a dip-tube for sample recovery from the membrane. An outlet tubing for membrane venting was also inserted at the top of the membrane compartment. A 23-gauge needle with luer lock was inserted at the other end of the venting tubing and a one ml syringe connected to serve as the venting device. A hole was drilled through the luer lock cap used to seal the membrane compartment. The dip-tube and venting tubing were superglued on the luer lock to form a tight air seal. After the device was fabricated, deionized water was used to ensure that all seals were intact before sample loading and to account for all hold up volumes in the tubing lines.

### Example 2. Device Operation and Electrochemical Setup

The carbon working and counter electrodes were connected to the Zahner electrochemical workstation to conduct impedance spectroscopy measurements. The system was set to galvanostat mode with a two-electrode setup (no reference electrode). The system was set to both a current and an amplitude of 50 nA. Frequency was scanned from 1 hz to 1 Mhz for calibration and optimization. Salt calibration was performed inline and 25 Khz was chosen as the optimum frequency of the alternating current (AC). Accordingly, in subsequent experiments, impedance data were recorded at 25 Khz, 50 nA current, and 50 nA amplitude.

For sugar detection, copper was used as a working electrode which was connected to a CH842C potentiostat. The same counter electrode used for obtaining impedance data was connected to the CH842C potentiostat. The reference electrode was also connected to the CH842C potentiostat. Linear sweep voltammetry was performed by sweeping the potential from 0 to 900 mV at a scan rate of 500 mV per second. Calibration of sugar concentration was conducted inline with optimized calibration found as the total current value at 720 mV.

Test samples of 1000 to 900 μL volume were introduced into the system though the 1 mL sampling syringe. The venting syringe was used to release air while sample was filled from the sampling line.

Sucrose and salt in varying concentrations, up to the maximum solubility in water, were used as the draw solutions. 200 mL of each solution was prepared in a glass beaker. Sample was introduced into the membrane compartment and the membrane submerged into the sucrose/salt solution.

Time dependent experiments were conducted by pulling 80 μL sample aliquots from the sampling syringe into the microchannel. Impedance data were collected for 10 seconds using the Zahner instrument and the instrument switched off. Next, using the potentiostat, voltammetry data was recorded for 5 seconds, following which the instrument was shut off. The 80 μL sample was reintroduced into the membrane compartment. To determine water volume loss over time, the entire sample content was removed from the membrane using the sampling syringe, the volume recorded, and the sample reintroduced into the membrane. The volume was determined at several 10 minute intervals.

### Example 3. Draw Solution and Osmotic Pressure

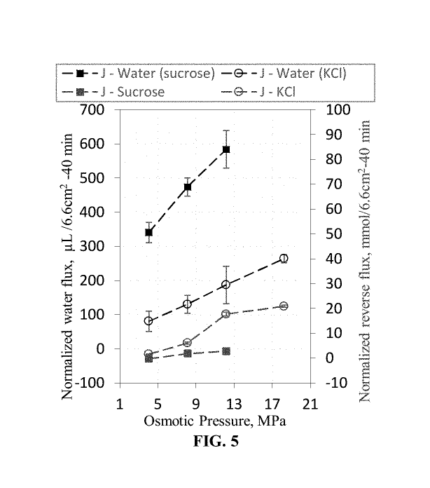

Experiments were conducted to determine the rate of water permeability through the membrane as a function of the osmotic pressure as the driving force. In addition, the ability of a low molecular weight cutoff membrane (100-500 Dalton cut-off, cellulose ester membrane) to prevent a solute in the draw solution from going through the membranes was studied using pure water as the test sample and varying the concentration of the draw solutions. The data obtained indicated that the dialysis membrane was much better at preventing sucrose molecules from passing through compared to salt ions (FIG. 5). This could be explained by the higher molecular weight of sucrose (342 g/mol) as compared to that of salt (75 g/mol). Therefore, sucrose experiences decreased diffusion through the cellulose ester membrane.

The slower diffusion rate of sucrose also allows for a three-fold increase in water permeability when compared to salt at similar osmotic pressures (FIG. 5). This could be explained by the membrane fouling mechanism of internal concentration polarization as investigated for large scale desalination membranes (Gray et al. 2006). The higher salt diffusive flux through the membrane significantly decreases the osmotic driving force while the lower sucrose diffusive flux maintains the osmotic driving force, allowing for increased water permeability. Using the maximum sucrose solubility in water, the present system was able to remove 600 μL of water in 40 minutes starting from a 900 μL sample with reduced reverse flux of sucrose into the sample.

### Example 4. Impact of pH and Temperature

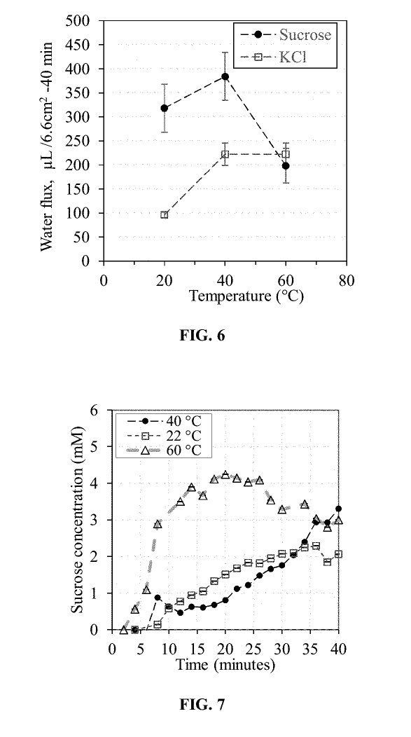

Bodily fluid samples have a wide range of pH values (4.0 to 8.0). The temperature can also vary depending on when the sample is analyzed. As such, the impact of pH and temperature on water permeability and the draw solute reverse flux was evaluated. When the osmotic pressure was kept constant at 4 MPa, water permeability increased with temperature as expected but the reverse flux also increased. Water permeability was found to be optimum at 40° C., at which point further increase in temperature negatively impacted water permeability in both sucrose and salt systems (FIG. 6). Further investigation of draw solute reverse flux confirmed that increased temperature leads to higher reverse flux rates. This is attributed to internal concentration polarization whereby the reverse flux rate causes a decline in the osmotic driving force and therefore significantly reduces the water flux rate. FIG. 7 confirms that reverse flux rates increases at elevated temperatures.

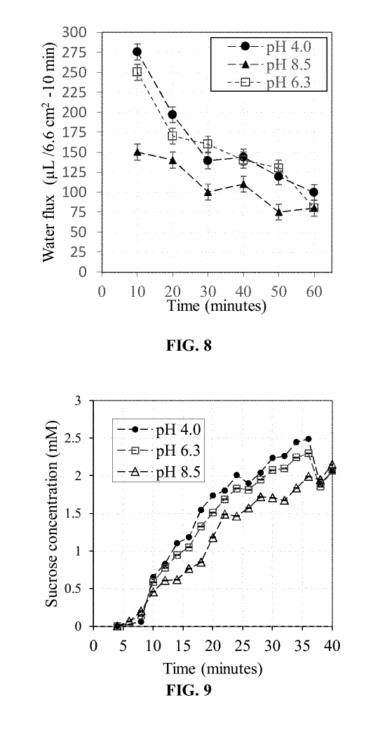

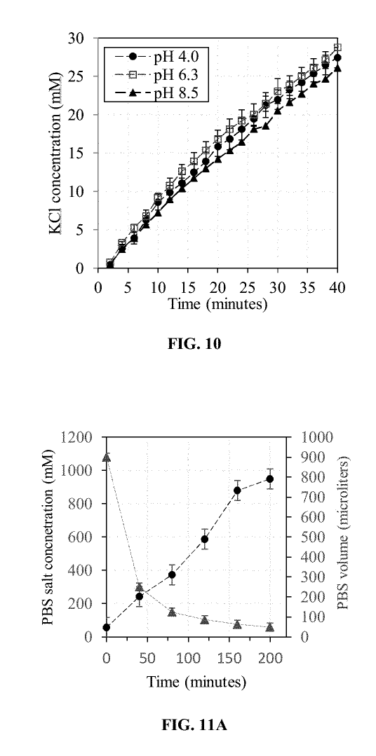

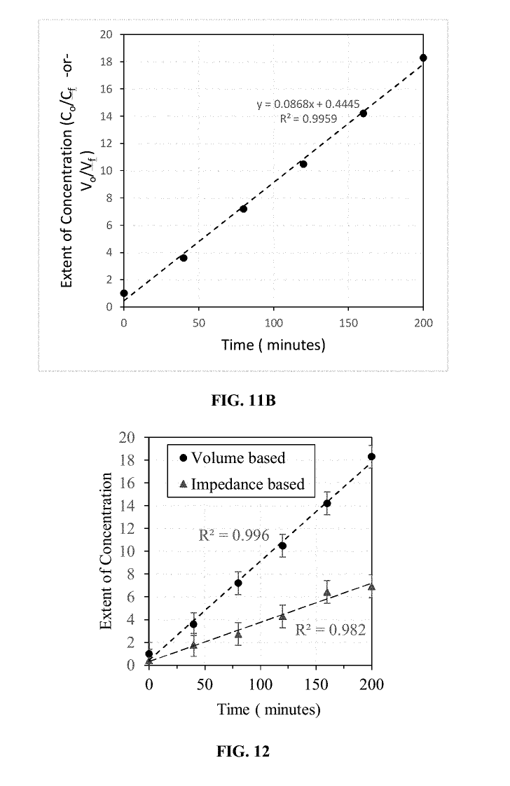

The impact of varying pH on water permeability was not as drastic. Making pH more basic was found to have a minimal impact in each of water flux (FIG. 8), sucrose flux (FIG. 9), and salt flux (FIG. 10). This could be explained by the shrinking effect of cellulose ester membranes in basic conditions as reported (Kaur et al., 2018).

### Example 5. Bodily Fluid Samples

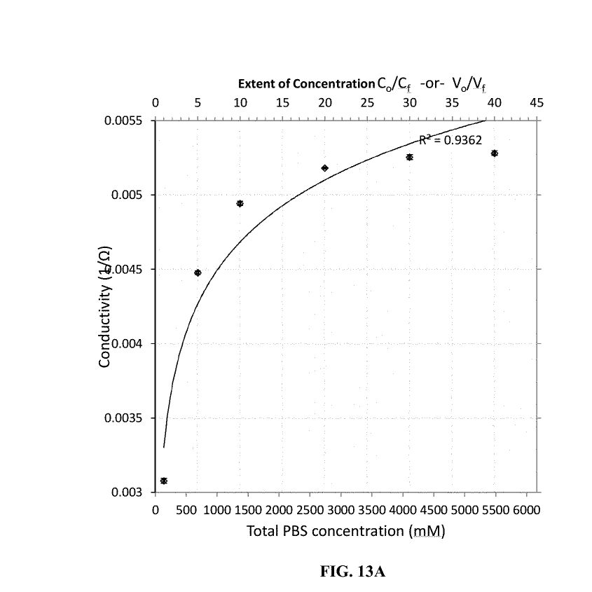

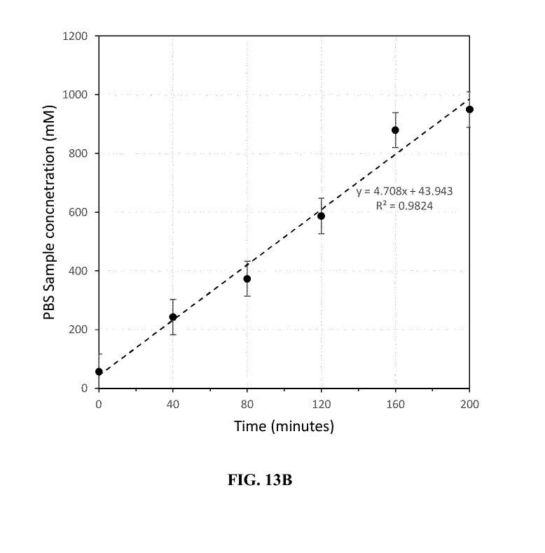

To study the extent to which body fluid samples could be concentrated, stock solutions of 10 mM PBS were used as representative body fluid samples (see FIGS. 11A, 11B, 13A and 13B). Impedance readings were used to determine the extent of concentration. The amount of volume lost during operation was also recorded to serve as comparison to the impedance method. As the sample becomes concentrated, the increase in salt content should decrease the impedance signal. Impedance signals previously measured as a function of salt concentration were used to convert impedance readings to salt concentrations. Sucrose at maximum solubility was used as the draw solution since it had previously been shown to have optimal water permeability rates. Samples were evaluated at room temperature to eliminate additional equipment. pH was not adjusted. Sucrose at solubility levels provided baseline pH values of 6.5. The use of sucrose for bodily fluid concentration is advantageous also because the reverse flux of sucrose does not interfere with impedance measurements. Separate time course experiments were performed to measure the volumetric water loss from the PBS samples and results compared with impedance data to determine if impedance values could, on their own, be reliably used as an indicator of sample concentration. The results indicated that salt concentration follows a steady state Fick's first law of diffusion as the salt steadily migrates across the membrane to the region with low salt (sucrose draw solute region). However, the water follows Fick's second law of diffusion where the internal concentration polarization created by the movement of both salt and sucrose diminish the water flux rate across the membrane.

Finally, the extent of sample concentration using volumetric approach was compared to the inline impedance based method (FIG. 12). The volumetric decrease is the true measure of concentration and it is not surprising that the impedance method may provide an underestimate because of the diffusive flux of salt across the membrane. Since, not all of the initial salt in the sample is retained within the membrane compartment, the conductivity is lower than it would otherwise have been. This can be readily seen when the extent of concentration is calculated using the two methods in FIG. 12.

### REFERENCES

Archibald M M, Rizal B, Connolly T, Burns M J, Naughton M J, Chiles T C. A Nanocoaxial Based Electrochemical Sensor for the Detection of Cholera Toxin. Biosensors & Bioelectronics 2015; 74: 406-410
G. T. Gray, J. R. McCutcheon, and M. Elimelech, “Internal concentration polarization in forward osmosis: role of membrane orientation,” Desalination, vol. 197, no. 1-3, pp. 1-8, 2006.
H. Kaur, V. K. Bulasara, and R. K. Gupta, “Influence of pH and temperature of dip-coating solution on the properties of cellulose acetate-ceramic composite membrane for ultra filtration,” Carbohydr. Polym., vol. 195, no. May, pp. 613-621, 2018.

As used herein, “consisting essentially of” allows the inclusion of materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

What is claimed is:

1. A device for concentrating and electrochemically detecting an analyte in an aqueous sample, the device comprising:
a first chamber for concentrating the sample, the chamber comprising an inlet for loading the sample into the chamber, an outlet for allowing the sample to exit the chamber; a working electrode, and a counter electrode, wherein the working electrode and counter electrode are disposed to contact the sample in the chamber;
a second chamber for a draw solution; and
a semipermeable membrane separating the first and second chambers.

2. A device for concentrating and electrochemically detecting an analyte in a sample, the device comprising:
a first chamber for concentrating the sample, the chamber comprising an inlet for loading the sample into the chamber and an outlet for allowing the sample to exit the chamber;
a second chamber for a draw solution;
a semipermeable membrane separating the first and second chambers;
a third chamber for electrochemically detecting the analyte in the concentrated sample from the first chamber, the third chamber comprising an inlet, an outlet, a working electrode, and a counter electrode, wherein the working electrode and counter electrode are disposed to contact the concentrated sample in the third chamber; and
a channel fluidically connecting the outlet of the first chamber with the inlet of the third chamber.

3. The device of claim 1, further comprising a reference electrode in the first chamber, wherein the reference electrode is disposed to contact the sample in the first chamber.

4. The device of claim 1, wherein the volume of the second chamber is greater than the volume of the first chamber.

5. The device of claim 1, wherein the second chamber is filled with a draw solution having an osmolarity higher than that expected for the sample.

6. The device of claim 1, wherein the device comprises two or more pairs of first and second chambers for progressive concentration of the sample, each pair separated by a semi-permeable membrane, wherein the pairs are fluidically connected in series via one or more channels from the outlet of one first chamber to the inlet of another first chamber, or to the inlet of a separate third chamber for electrochemically detecting the analyte in the concentrated sample.

7. The device of claim 1, wherein a surface of the working electrode is functionalized to specifically bind the analyte.

8. The device of claim 1 that is configured as a point of care sensor for detecting or quantifying an analyte from a patient sample.

9. The device of claim 1 that is configured as a sensor for use with a bioreactor, wherein the device detects or quantifies an analyte produced by the bioreactor.

10. The device of claim 1 configured for inline monitoring of a continuously produced fluid sample.

11. A system comprising the device of claim 1 and a potentiostat connected to the working electrode, counter electrode, and optionally to a reference electrode via electrode leads.

12. The system of claim 11, further comprising a processor and memory for evaluating and/or quantifying the analyte, and optionally comprising a wireless transmitter.

13. The system of claim 12 having a wireless transmitter, further comprising a separate receiver device for receiving signals remotely from the device for concentrating and electrochemically detecting the analyte.

14. The system of claim 12 configured or programmed to detect or quantify a concentration factor of the sample during a process of concentrating the sample.

15. The system of any claim 12 configured or programmed to change or replenish a draw solution in the second chamber.

16. A method for concentrating an analyte in an aqueous sample and electrochemically detecting and/or quantifying the analyte, the method comprising:
(a) providing the device of claim 1, wherein the second chamber comprises a draw solution;
(b) introducing the sample into the first chamber through the inlet;
(c) concentrating the sample by forward osmosis, whereby water is transferred from the first to the second chamber;
(d) establishing an electrical potential difference between the working electrode and the counter electrode;
(e) measuring a current from an electrochemical reaction involving the analyte at the working electrode; and
(f) determining a presence, amount, or concentration of the analyte in the sample from the current measured in (e) and a concentration factor achieved in (c).

17. The method of claim 16, further comprising determining the concentration factor achieved in (c) from conductivity measurements of the sample before, during, and/or after performing (c).

18. The method of claim 16, wherein (f) comprises comparing the current measured in (e) with a known correlation between the current and concentration of the analyte.

19. The method of claim 16, wherein the draw solution comprises sucrose or potassium chloride.

20. The method of claim 16, wherein the sample is a body fluid of a patient, a cell culture medium, or a solution from a bioreactor.

21. The method of claim 16, wherein the detection limit of the analyte is increased at least 10-fold by the method compared to an electrochemical measurement made using the sample without concentration.
